(19) United States
(12) Patent Application Publication
(10) Pub. No.: US 2008/0127891 A1
(43) Pub. Date: Jun. 5, 2008

(54) CONCAVE LASER-RESURFACED PART, METHOD AND DEVICE FOR PRODUCING IT

(75) Inventors: Didier Dezert, Chapeiry (FR); Jean-Baptiste Crepin, Atlanta, GA (US)

Correspondence Address: WILLIAM H. EILBERG, THREE BALA PLAZA, SUITE 501 WEST, BALA CYNWYD, PA, 19004, US

(73) Assignee: TECHNOGENIA, Saint Jorioz (FR)

(21) Appl. No.: 11/948,472

(22) Filed: Nov. 30, 2007

(30) Foreign Application Priority Data
Dec. 2, 2006 (FR) 06 55286

(51) Int. Cl. B23K 26/20; B05C 9/02; H01S 3/08

(52) U.S. Cl. 118/620; 219/121.6; 372/101

(57) ABSTRACT

Device for resurfacing a concave face (2) of a tubular part (1) by supplying resurfacing material and energy by a laser, comprising a laser source for generating a laser beam (9), resurfacing material delivery means (5) based on hard refractory particles and metal alloy particles, in order to deliver the resurfacing material close to a resurfacing zone (6) on the concave face (2) of the tubular part (1) to be resurfaced, laser beam delivery means (7) and directing means (8) for directing the laser beam (9) into the resurfacing zone (6). The laser source is a diode laser (4) and the laser beam delivery means (7) conduct the latter over a penetration length (L) along a penetration direction and then the directing means (8) deflect the laser beam (9) into a radial direction (II-II) away from the penetration direction, so that the laser source may lie outside the tubular part (1) and the laser beam delivery means (7) may be axially engaged completely or partly in the tubular part (1).

### TECHNICAL FIELD OF THE INVENTION

The present invention relates to a device for resurfacing a part by supplying resurfacing material containing hard refractory particles and metal alloy particles.

More particularly, the invention relates to a device for resurfacing a concave face of a tubular part by supplying resurfacing material in powder form and by supplying energy by a laser.

Tubular parts having a hard refractory or metal alloy layer on their concave face are commonly used so as to be cut up into sections of variable length in order to produce bearings for the guiding of rotating shafts. Such tubular parts may also constitute cylinders for guiding the pistons in an internal combustion engine.

Various methods are already known for resurfacing the concave face of a tubular part.

Among these, the resurfacing of a concave face of a tubular part by supplying resurfacing material and energy by a laser proves to be particularly effective. This is because using a laser means that only a very localised and shallow heat-affected zone is formed on the concave face of the tubular part. The use of a laser thus prevents deterioration of the properties of the constituent material of the tubular part which has undergone, prior to the resurfacing, an important heat treatment for the purpose of giving it particular mechanical and chemical properties suitable for its subsequent conditions of use.

In document WO 00/23718 A1, there is a description of a concave face of a tubular part being resurfaced by supplying resurfacing material and energy by a laser.

That document describes a laser source that generates a laser beam directed onto a local zone of the concave face of the tubular part. Resurfacing material is delivered into this local zone and is heated by the energy of the laser beam. The laser source is placed radially facing the face to be resurfaced, i.e. inside the tubular part. This means that only tubular parts having a diameter sufficient to contain the laser source can be resurfaced. Thus, the diameter of the tubular parts on which it is possible to carry out resurfacing is very restrictively limited.

It has already been imagined to use a laser source associated with means for conducting the energy of the laser beam right to a zone to be treated inside a tube, the laser source then being able to remain outside the tube. The difficulty is then to ensure that the laser energy is produced and conducted effectively, reliably and inexpensively.

For example, document US 2002/0164436 A1 describes a method and a device for laser-resurfacing tubular parts, such as internal combustion engine cylinders. A diode laser generates a laser beam, and an optical system conducts the laser beam into the tube and makes it exit therefrom radially in order to strike a treatment zone. Resurfacing material delivery means carry a powdered resurfacing material, based on an alloy powder, into the resurfacing zone.

In this way, the laser source may be on the outside of the tubular part, and the optical system is engaged axially in the tubular part in order to deliver the laser energy into the treatment zone inside the tubular part.

The document provides no precise description of the optical system and the resurfacing material delivery means.

At the very most, FIG. 6 illustrates a resurfacing material projection nozzle, which is placed laterally alongside the optical laser-conducting device.

One problem, mentioned moreover by the above document, is the heating produced by the energy of the laser striking the treatment zone. This heating may impair the effectiveness of the laser and may disturb the progress of the pulverulent resurfacing material into the treatment zone. To remedy this, the document proposes delivering the pulverulent material by a vibrating conveyor or a screw.

However, this heating also affects the optical laser-conducting device and may damage it, in particular in small-diameter tubular parts in which the atmosphere is confined.

This heating problem is all the more crucial when it is desired to resurface a tubular part with a material containing refractory particles, used for their high hardness. This is because a large amount of energy has to be supplied to produce an effective hard resurfacing layer.

Also known, from document JP 2000-153382 A, is a laser beam machine capable of laser machining an object when the latter is placed under water.

The document describes a device for machining a tube, which includes an optical fibre conducting a laser beam to a first lens unit which converts the laser beam into parallel rays. Two successive mirrors then direct the laser beam onto a second lens unit, which makes the laser beam converge on a zone to be machined.

In that document, neither resurfacing nor a diode laser are mentioned, and the presence of water itself provides cooling and avoids the heating problems, which are not mentioned in that document.

Document EP 1 247 878 A1 describes a device for resurfacing a concave face of a tubular part, comprising a diode laser source and means for delivering resurfacing material via pipes. A lightguide or optical fibre conducts the laser beam over an axial penetration length in the tubular part. The resurfacing material is a silicon-based powder. On leaving the optical device, the laser beam is oblique.

It appears that none of these known devices is actually appropriate for reliably and inexpensively conducting the laser energy from an external laser source of the diode type right to a resurfacing zone placed inside a tubular part.

In particular, the conduction of the laser beam by an optical fibre inside a small-diameter tubular part does not appear to be very reliable, because of the excessive heating of the optical fibre, which furthermore does not allow the laser beam to be effectively directed perpendicularly to the resurfacing zone.

The optical lens devices described in the above documents are not satisfactory either, and they incur considerable risks of degrading the optical components during use at high temperature.

### SUMMARY OF THE INVENTION

Thus, the present invention is aimed at devising a device for resurfacing the concave face of a tubular part that consists of inexpensive optical elements, the device having to be free of any risk of degrading or lowering the effectiveness resulting from heating the inside of a tubular part to be resurfaced, so as to be able to use resurfacing materials containing refractory powders.

To achieve this, the idea at the basis of the invention is to produce the laser beam by a diode laser source and to conduct the laser beam into the part to be resurfaced with a reduced surface energy density by means of commonplace and inexpensive optical components.

The diode laser source is effective and inexpensive but it does have the drawback of producing a divergent laser beam, which is of course incapable of suitably propagating along the penetration direction right to the resurfacing zone. The aim of the invention is also to solve this difficulty, using appropriate optical means.

To achieve these objects and other ones, the invention provides a device for resurfacing a concave face of a tubular part by supplying resurfacing material and energy by a laser, comprising:
a diode laser for generating a laser beam,
resurfacing material delivery means for delivering the resurfacing material close to a resurfacing zone on the concave face of the tubular part to be resurfaced,
laser beam delivery means and directing means for directing the laser beam into the resurfacing zone, the laser beam delivery means conducting the laser beam over a penetration length along a penetration direction and then the directing means deflecting the laser beam into a radial direction away from the penetration direction; according to the invention:
the resurfacing material is based on hard refractory particles and metal alloy particles,
the laser beam delivery means and the directing means comprise a first convergent lens, the optical axis of which is oriented along the penetration direction, which lens receives the laser beam coming from the diode laser,
the laser beam delivery means and the directing means comprise a mirror which receives the laser beam coming from the first convergent lens and sends said beam along the radial direction away from the penetration direction,
the laser beam delivery means and the directing means comprise a second convergent lens which receives the laser beam coming from the mirror and makes the laser beam converge close to the resurfacing zone, and
an optical insert makes the laser beam coming from the diode laser along the penetration direction converge near the object focal point of the first convergent lens.

Thanks to this arrangement, the laser beam is initially concentrated at the entry of the optical device, downstream of the optical insert, and then becomes a parallel-ray beam after it has passed through the first convergent lens. The laser beam then strikes the mirror on a maximized surface, avoiding heating and altering it, and then is concentrated by the second convergent lens.

The optical means are simple and inexpensive, and their arrangement optimises their operation by making them largely insensitive to the heating.

In particular, the relatively little heating caused by the laser beam passing through the optical lenses and onto the mirror is that there is no risk of degrading them, even in the presence of the surrounding heating produced by the impact of the laser beam on the zone to be resurfaced inside the tubular part.

One advantage is that it is possible to produce a low-cost device for resurfacing a concave face of a tubular part by supplying resurfacing material and energy by a laser using commonplace components, and ensuring effective confinement of the laser beam.

The use of a diode laser as laser source proves to be particularly advantageous owing to its compactness, its ease of high-frequency modulation, its low operating voltage and its low power consumption thanks to excellent efficiency.

Furthermore, a diode laser emits a slightly divergent laser beam. As a result, the laser beam may have energy concentration per unit area that is lower than that of conventional gas laser sources, so that it is easier to convey said beam without running the risk of damaging the transmission members, such as mirrors or lenses.

The laser beam delivery means and the directing means are simple and inexpensive, produced using standard, inexpensive and compact optical components.

The lenses and the mirror are also perfectly capable of withstanding the surface energy density of the laser beam from a diode laser.

The presence of the optical insert primarily makes it possible to extend the length of penetration along which the laser beam from the diode laser is delivered.

Furthermore, owing to the fact that the optical insert makes the laser beam coming from the diode laser converge near the object focal point of the first convergent lens, the first convergent lens transmits the laser beam in the form of substantially parallel rays. This is a good compromise between the fact of preserving all of the energy of the laser beam without any loss and the fact of delivering the laser beam with the lowest possible surface energy density so as to heat the optical components (convergent lenses, mirror, etc.) as little as possible.

Advantageously, the optical insert may comprise a third convergent lens making the laser beam coming from the diode laser converge near the object focal point of the first convergent lens.

Thus, a simple optical insert is produced for collecting the divergent laser beam at the output of the diode laser and for delivering it along the penetration direction right to the object focal point of the first convergent lens.

Preferably, arrangements may be provided such that:
the optical insert comprises a fourth convergent lens, which receives the laser beam coming from the diode laser;
the third convergent lens receives the laser beam coming from the fourth convergent lens,
the diode laser is placed close to the object focal point of the fourth convergent lens, and
the image focal point of the third convergent lens coincides substantially with the object focal point of the first convergent lens.

By using a fourth convergent lens, the length of penetration over which the laser beam is delivered can be further extended. A person skilled in the art will readily understand that the length of penetration will depend on the focal lengths of the various convergent lenses used in the laser beam delivery means and in the optical insert.

Preferably, the optical insert may include an optical fibre that collects the laser beam coming from the diode laser and delivers it close to the object focal point of the first, third or fourth convergent lens, depending on the embodiment in question.

The optical fibre allows the laser beam to be delivered over a great length while minimising energy losses. The use of an optical fibre also means that the laser beam delivery means and the directing means can penetrate into the tubular part without the laser source having to be moved, it being possible for the optical fibre to be provided with slack.

Preferably, arrangements may be provided such that:
the fourth convergent lens is substantially perpendicular to the penetration direction and substantially parallel to the radial direction,
the second convergent lens and the fourth convergent lens are placed radially on either side of the penetration direction,
the optical insert includes an additional mirror which receives the laser beam coming from the fourth convergent lens and sends the laser beam back along the penetration direction, and
the optical fibre is placed as a winding on a winding device.

Advantageously, arrangements may be provided such that the optical insert, the first convergent lens and the mirror are contained within a double-walled hollow confinement tube, a coolant circulating between the walls.

The hollow confinement tube is used for holding the constituent components of the laser beam delivery means and to keep them in relative position, while still ensuring sure and reliable confinement of the laser beam.

The double-walled hollow confinement tube makes it possible for the components that it confines to be effectively cooled so as to avoid any deterioration caused by heating when the device is being used.

Preferably, arrangements are provided such that:
the radial direction along which the mirror sends back the laser beam coming from the first convergent lens is substantially perpendicular to the penetration direction,
the optical axis of the second convergent lens substantially coincides with the radial direction,
the resurfacing material delivery means comprise a nozzle with a generally conical internal wall with its point oriented towards the outlet and the apex of which is pierced, thus forming the outlet orifice, and
the outlet orifice of the nozzle is substantially coaxial with the optical axis of the second convergent lens.

If the direction of penetration is substantially horizontal, the radial direction is thus vertical. This enables the resurfacing material to flow under gravity to the point where the laser beam strikes the face to be resurfaced.

Preferably, the device may comprise:
a mandrel for rotating the tubular part to be resurfaced, and
first displacement means for providing a relative displacement along the penetration direction between, on the one hand, the tubular part to be resurfaced and, on the other hand, the subassembly comprising the laser beam delivery means and the directing means, in order to make this subassembly penetrate into the tubular part to be resurfaced.

Complementarily, the device may include second displacement means for providing a relative displacement along a radial direction between, on the one hand, the tubular part to be resurfaced and, on the other hand, the subassembly comprising the laser beam delivery means and the directing means.

### BRIEF DESCRIPTION OF THE DRAWINGS

Other objects, features and advantages of the present invention will become apparent from the following description of particular embodiments, in conjunction with the appended figures in which:

FIG. 1 is a schematic sectional view of a first embodiment of the invention;

FIG. 2 is a schematic sectional view of a second embodiment of the invention;

FIG. 3 is a schematic sectional view of a third embodiment of the invention;

FIG. 4 is a schematic sectional view of a fourth embodiment of the invention;

FIG. 5 is a schematic sectional view of a fifth embodiment of the invention;

FIG. 6 is a schematic sectional view of a sixth embodiment of the invention; and

FIG. 7 is a schematic sectional view of a seventh embodiment of the invention.

### DESCRIPTION OF PREFERRED EMBODIMENTS

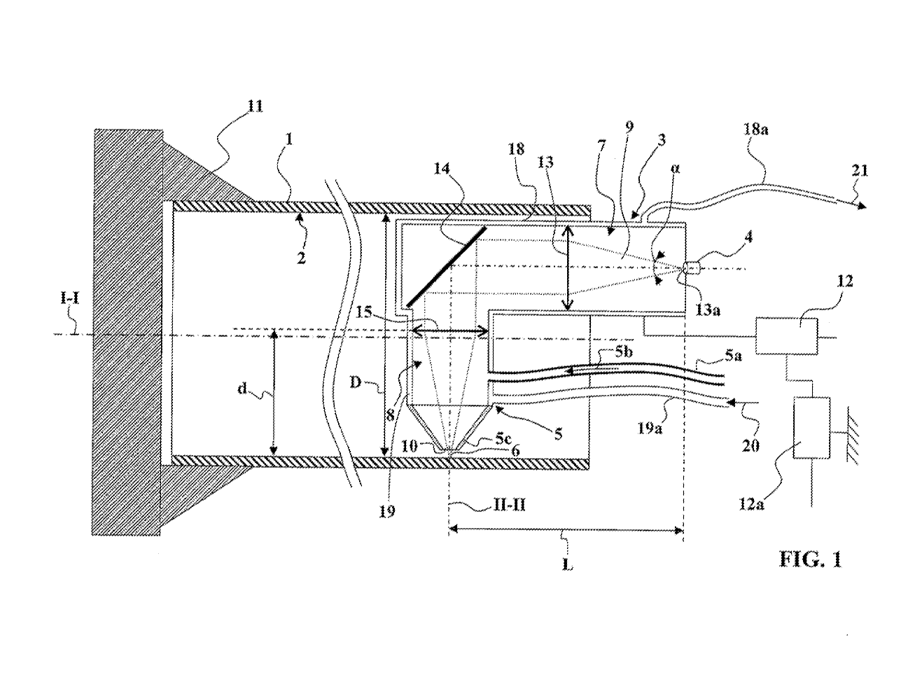

FIG. 1 shows a tubular part 1 having a concave face 2 to be resurfaced. The tubular part 1 extends along a longitudinal axis I-I.

The resurfacing device includes a laser source, which is a diode laser 4. Although the diode laser 4 is shown here as being very compact, it should be understood that the means for supplying and controlling the diode laser 4 are not shown and that these may take up a very considerable amount of space, and larger than the inside diameter D of the tubular part 1, so that it is not possible for the diode laser 4 and its supply and control means to penetrate inside the tubular part 1.

The resurfacing device includes resurfacing material delivery means 5, the resurfacing material being based on hard refractory particles and metal alloy particles. The resurfacing material delivery means 5 deliver the resurfacing material close to a resurfacing zone 6 on the concave face 2 of the tubular part 1 to be resurfaced.

The resurfacing device includes a subassembly 3 comprising laser beam delivery means 7 and directing means 8 for directing the laser beam 9 into the resurfacing zone 6.

The laser beam delivery means 7 conduct the laser beam 9 generated by the diode laser 4 over a penetration length L along a penetration direction which may coincide with the longitudinal axis I-I of the tubular part 1. The directing means 8 deflect the laser beam 9 along a radial direction II-II away from the penetration direction.

The diode laser 4 lies outside the tubular part 1, and the laser beam delivery means 7 may be axially engaged, completely or partly, in the tubular part 1.

During use of the resurfacing device, resurfacing material based on hard refractory particles and metal alloy particles is delivered by the resurfacing material delivery means 5 which comprise, as shown in FIG. 1, a hose 5a along which the resurfacing material flows in the sense and direction defined by the arrow 5b. The resurfacing material is conveyed by a gas stream, preferably a stream of inert gas.

The resurfacing material delivery means 5 comprise a nozzle 5c with a generally conical internal wall with its point oriented towards the outlet and the apex of which is pierced, thus forming an outlet orifice 10. The outlet orifice 10 of the nozzle 5c is substantially coaxial with the radial direction II-II.

The nozzle 5c used may advantageously be in accordance with the teachings of document U.S. Pat. No. 5,418,350 included as reference. Such a nozzle allows the resurfacing material to be effectively directed to the only resurfacing zone 6, avoiding any loss of material. Furthermore, such a nozzle preheats the resurfacing material that passes through it, making it possible to reduce the laser power needed to melt the alloy and the resurfacing zone, and thus further reducing the heating of the optical laser beam delivery means 7.

The resurfacing material delivery means 5 thus deliver the resurfacing material close to the outlet orifice 10 where the resurfacing material is further heated by the laser beam 9 until the metal alloy particles melt. The heated resurfacing material is then deposited on the resurfacing zone 6 of the concave face 2 of the tubular part 1, where the metal alloy cools and solidifies again, to produce the resurfaced layer of the concave face 2.

In the embodiment illustrated in FIG. 1, the radial direction II-II is vertical and the penetration direction, which coincides with the longitudinal axis I-I of the tubular part 1, is horizontal. The resurfacing material transported by a gas stream thus flows towards the outlet orifice of the nozzle 5c, aided by gravity.

A mandrel 11 is used to hold and rotate the tubular part 1 to be resurfaced. First displacement means 12 provide relative displacement along the penetration direction between, on the one hand, the tubular part 1 to be resurfaced and, on the other hand, the subassembly 3 comprising the laser beam delivery means 7 and the directing means 8, in order to make this subassembly 3 penetrate into the tubular part 1 to be resurfaced. Second displacement means 12a provide relative displacement along the radial direction II-II between, on the one hand, the tubular part 1 to be resurfaced and, on the other hand, the subassembly 3 comprising the laser beam delivery means 7 and the directing means 8.

The combination of the mandrel 11 and the first displacement means 12 allows the entire concave face 2 of the tubular part 1 to be resurfaced.

The combination of the mandrel 11 and the second displacement means 12a allows, for its part, the distance between the outlet orifice 10 and the resurfacing zone 6 to be adjusted, and to do so whatever the diameter D of the tubular part 1. Thus, it is possible for the laser beam 9 to strike the resurfacing zone 6 as a light spot of larger or smaller radius, and with a greater or lesser surface energy density.

In the embodiment shown in FIG. 1, the mandrel 11 is fixed positionwise and can rotate about the axis I-I, whereas the laser beam delivery means 7 and the directing means 8 can be moved in axial translation along the axis I-I and in radial translation along the radial direction II-II.

In the embodiment illustrated in FIG. 1, the laser beam delivery means 7 and the directing means 8 comprise:
a first convergent lens 13, the optical axis of which is oriented along the penetration direction (i.e. parallel to the axis I-I), which lens receives the laser beam 9 coming directly from the diode laser 4,
a mirror 14 which receives the laser beam 9 coming from the first convergent lens 13 and sends it back along the radial direction II-II away from the penetration direction, and
a second convergent lens 15 that receives the laser beam 9 coming from the mirror 14 and makes the laser beam 9 converge near the resurfacing zone 6.

The laser beam delivery means 7 and the directing means 8 are thus produced simply and inexpensively using compact inexpensive standard optical components. It has thus been possible to carry out the resurfacing in tubes having an inside diameter of less than 100 mm.

Furthermore, the lenses 13 and 15 and the mirror 14 are capable of withstanding the surface energy density of the diode laser 4.

Finally, it is advantageous to use a diode laser 4 whose wavelength permits good absorption of the energy by the tubular part 1. The laser beam delivery means 7 and the directing means 8 will thus be less subject to heating, the energy reflected by the tubular part 1 being less. This is because lenses and mirrors used in optics have characteristics that vary when being heated, which could impair the efficiency of the device.

The laser beam 9 emanates from the diode laser 4 as substantially divergent rays in the form of a cone having an apex angle equal to the angle α.

In the case of FIG. 1, the diode laser 4 is placed at the object focal point 13a of the first convergent lens 13. The first convergent lens 13 thus transmits the laser beam 9 in the form of parallel rays which strike the surface of the mirror 14. The laser beam 9 is then reflected through approximately 90°, still in the form of parallel rays, reaching the second convergent lens 15, which makes the laser beam 9 converge near the resurfacing zone 6 on the concave face 2 of the tubular part 1.

A person skilled in the art will understand that the second convergent lens 15 may be replaced equivalently by another lens or a set of several other lenses so as to adjust the convergence distance d of the laser beam 9. However, it is judicious to choose the second convergent lens 15 so as to make the laser beam 9 converge close to the outlet orifice 10 of the nozzle 5c. The laser beam 9 thus strikes the resurfacing zone 6 with substantially maximum energy for heating the resurfacing material sufficiently and thus guaranteeing the quality of the resurfacing. Furthermore, by making the laser beam 9 converge close to the outlet orifice 10 it is possible to position the nozzle 5c in close proximity to the concave face 2, thereby making it possible to carry out resurfacing in tubular parts of very small inside diameter.

The fact of placing the diode laser 4 at the object focal point 13a of the first convergent lens 13 allows the laser beam 9 to be delivered in the form of a beam of parallel rays over the entire optical path going from the first convergent lens 13 to the second convergent lens 15. Thus, along the optical path going from the first convergent lens 13 to the second convergent lens 15, there is a good compromise between the fact of maintaining the energy of the laser beam 9 without any loss and the fact of delivering the laser beam 9 with the lowest surface energy density. In particular, this allows the optical components, namely the convergent lenses 13 and 15 and the mirror 14, to be heated as little as possible during use of the resurfacing device, for the purpose of preventing them from being damaged and of minimising the energy losses of the laser beam 9.

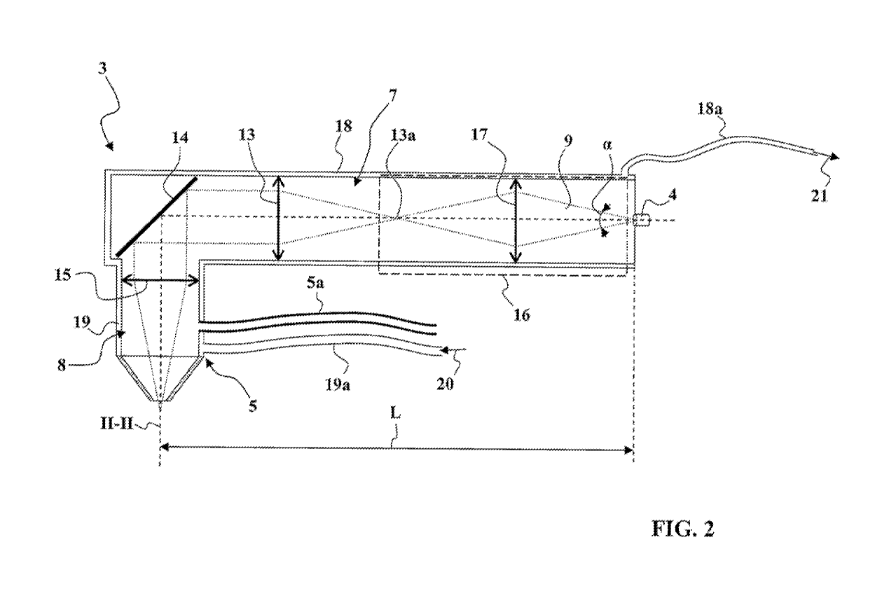

In the embodiments illustrated in FIGS. 2, 3 and 4, the resurfacing device furthermore includes an optical insert 16 that makes the laser beam 9 coming from the diode laser 4 converge in the penetration direction close to the object focal point 13a of the first convergent lens 13.

In the case of the embodiment illustrated in FIG. 2, the optical insert 16 comprises a third convergent lens 17 making the laser beam 9 coming from the diode laser 4 converge near the object focal point 13a of the first convergent lens 13.

The penetration length L may thus be substantially increased relative to the embodiment illustrated in FIG. 1.

In the embodiments illustrated in FIGS. 1 to 4, the laser beam delivery means 7 and the directing means 8 are contained within double-walled hollow confinement tubes 18 and 19, a coolant circulating between the walls. This coolant is delivered into the double wall of the confinement tubes 18 and 19 by coolant delivery means 18a and 19a, which are hoses.

The first convergent lens 13, the second convergent lens 15, the mirror 14 and the optical insert 16 (in the case of the embodiments shown in FIGS. 2 to 4) are thus effectively cooled so as to prevent any damage.

In the embodiments illustrated in FIGS. 1 to 4, the confinement tubes 18 and 19 are interconnected so as to produce a continuous double wall. The coolant is thus delivered by the hose 19a as illustrated by the arrow 20 and leaves via the hose 18a as illustrated by the arrow 21, after said coolant has circulated between the two walls of the confinement tubes 18 and 19.

It is advantageous to provide such cooling means as delivering the laser beam 9 over a long penetration length L cannot be accomplished without loss, especially owing to the imperfections in the convergent lenses 13 and 15, the mirror 14 and the optical insert 16, owing to their approximate relative arrangements and owing to the diffusion of the energy from the laser beam 9 into the gas and dust present in the tubes 18 and 19.

Rays of the laser beam 9 may thus strike the confinement tubes 18 and 19 and heat them. The circulation of the coolant allows the damage caused by heating the confinement tubes 18 and 19 to be minimised and allows to cool all the components of the laser beam delivery means 7 and the directing means for directing the laser beam 9.

In the embodiments illustrated in FIGS. 2 to 4, it may be seen that the laser beam 9 progressively converges and then diverges between the convergent lenses 17 and 13. It follows that, in this section of the path, the laser beam 9 is concentrated and held further away from the wall of the confinement tube 18, reducing the risk of heating the tube 18.

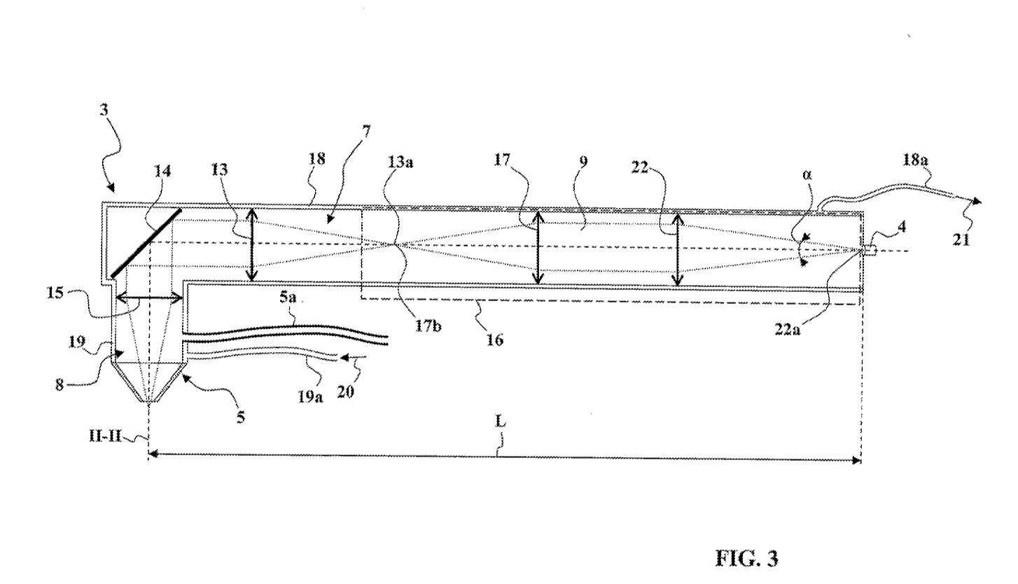

In the embodiment illustrated in FIG. 3, the optical insert 16 furthermore includes a fourth convergent lens 22 that receives the laser beam 9 coming from the diode laser 4. The third convergent lens 17 receives the beam coming from the fourth convergent lens 22. The diode laser 4 is placed near the object focal point 22a of the fourth convergent lens 22. The image focal point 17b of the third convergent lens 17 coincides substantially with the object focal point 13a of the first convergent lens 13.

Again, the penetration length L over which the laser beam 9 is delivered is substantially extended. This makes it possible to resurface the concave face 2 of a longer tubular part 1.

In the embodiment shown in FIG. 3, since the diode laser 4 is placed near the object focal point 22a of the fourth convergent lens 22, the convergent lens 22 sends the laser beam 9 in the form of parallel rays back to the third convergent lens 17.

Between the convergent lenses 22 and 17, the rays of the laser beam 9 are thus closer to the walls of the confinement tube 18. Because of the manufacturing imperfections in the convergent lenses 22 and 17, it is possible that some of the rays of the laser beam 9 will thus strike the walls of the confinement tube 18 and cause it to heat up.

A person skilled in the art will thus readily understand that the most opportune way of increasing the penetration length L is to provide convergent lenses 17 and 13 having matched focal lengths and to place them substantially in the particular manner illustrated in the embodiments shown in FIGS. 2 and 3.

However, the way in which the laser beam 9 is delivered between the convergent lenses 22 and 17 remains very effective in the case of high-quality convergent lenses 22 and 17.

As an alternative to the optical insert 16 of FIG. 3, it is possible to attempt to use a device having convergent and divergent lenses arranged alternately so as to make the laser beam 9 converge and then diverge over a long length. However, such a solution will prove to be less economic than that illustrated in FIG. 3, since it will require more lenses and the quality of the lenses will have to be perfect so as to minimise the energy losses of the laser beam 9.

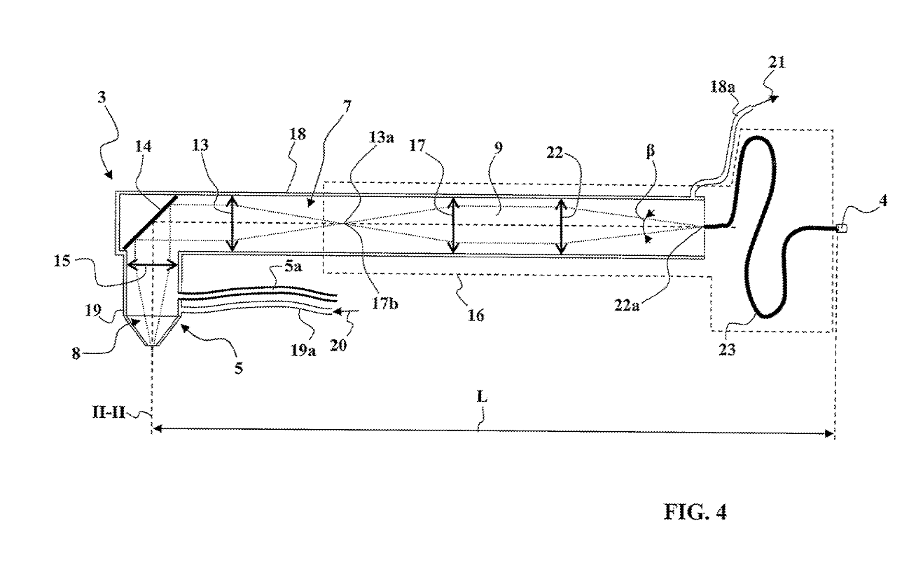

In the embodiment illustrated in FIG. 4, the optical insert 16 furthermore includes an optical fibre 23 that collects the laser beam 9 coming from the diode laser 4 and delivers it close to the object focal point 22a of the fourth convergent lens 22.

By using the optical fibre 23 it is possible to deliver the laser beam 9 coming from the diode laser 4 over a long length with very few energy losses.

Close to the object focal point 22a, the laser beam 9 emerges from the optical fibre 23 in the form of divergent rays in the form of a cone with an apex angle of β. The laser beam 9 is then treated in the same way as in the embodiment illustrated in FIG. 3. The presence of the optical fibre 23 again makes it possible to significantly extend the penetration length L. Furthermore, from the configuration illustrated in FIG. 4, it is possible to displace the confinement tubes 18 and 19 along the penetration direction while still keeping the diode laser 4 (and its supply and control means) fixed until the optical fibre 23 is entirely stretched between the object focal point 22a and the diode laser 4. The resurfacing device according to the invention thus becomes “telescopic”, with all the advantages that this may entail in terms of compactness.

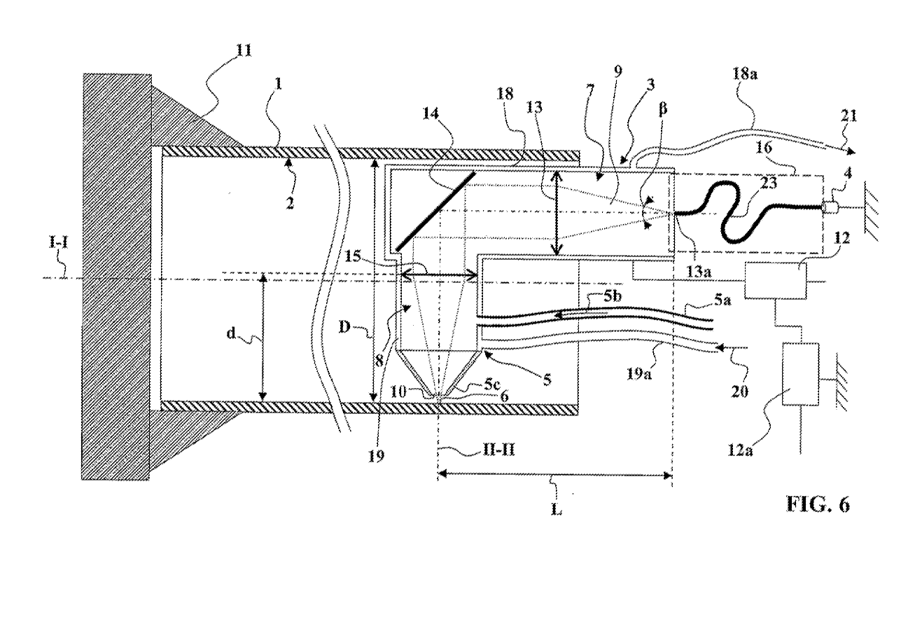

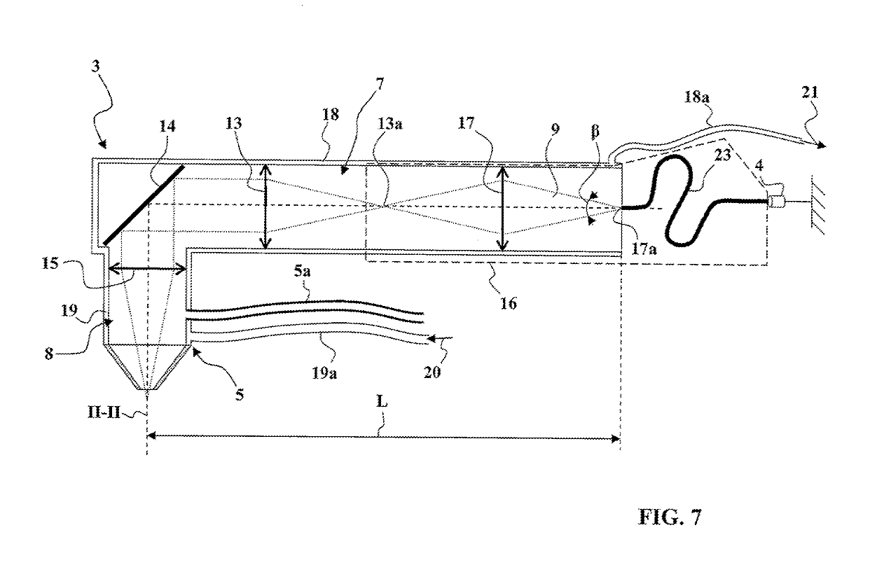

The same effects are obtained by the embodiments shown in FIGS. 6 and 7, which are alternative forms of the embodiments illustrated in FIGS. 1 and 2.

To do this, optical fibres 23 collect the laser beam 9 coming from the diode laser 4 and deliver it close to the object focal point 13a of the first convergent lens 13 (FIG. 6) or the object focal point 17a of the third convergent lens 17 (FIG. 7), respectively.

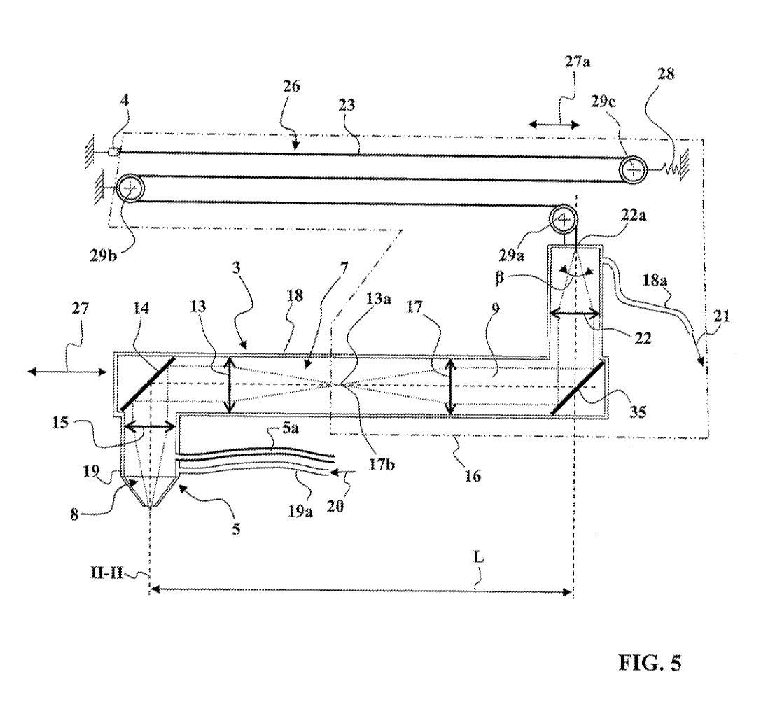

The fifth embodiment shown in FIG. 5 is an alternative form of the fourth embodiment. It may be observed in FIG. 5 that:
the fourth convergent lens 22 is substantially perpendicular to the penetration direction and substantially parallel to the radial direction II-II,
the second convergent lens 15 and the fourth convergent lens 22 are placed radially on either side of the penetration direction,
the optical insert 16 includes an additional mirror 35 which receives the laser beam 9 coming from the fourth convergent lens 22 and sends the laser beam 9 back along the penetration direction, and
the optical fibre 23 is placed as a winding on a winding device 26.

The entire optical fibre 23 is thus arranged so as to be wound over a winding device 26 above the resurfacing device, so that there is no risk of said fibre impeding the operations being carried out below. This also avoids the risk of damaging the optical fibre 23 by the various actions of the operators, an optical fibre being relatively fragile and having to be handled delicately.

The winding device 26 comprises several pulleys or cylinders 29a-29c. The radius of the pulleys or cylinders 29a-29c is such that the optical fibre 23 is not bent beyond a limit above which the laser beam 9 would suffer losses in the optical fibre 23, and beyond which the optical fibre 23 would be damaged.

The pulley or cylinder 29a is attached to the resurfacing device. The diode laser 4 is fixed, as is the pulley or cylinder 29b. The pulley or cylinder 29c can move translationally with respect to the diode laser 4 and to the pulley or cylinder 29b by means of a spring 28 or other equivalent device, such as a cylinder actuator or a counterweight.

During the displacement of the resurfacing device along the penetration direction by movements illustrated by the double arrow 27, the pulley or cylinder 29c will undergo the movements illustrated by the arrow 27a thanks to the stretching or shortening of the spring 28. The available length of optical fibre 23 thus varies automatically so as to accompany the displacements of the resurfacing device along the penetration direction. The spring 28 is chosen to exert a sufficiently small tensile force on the optical fibre 23 so as not to risk damaging it. The winding device 26 described above must be considered as a simple non-limiting example and may be adapted to the embodiments shown in FIGS. 6 and 7 without thereby departing from the scope of the present invention.

As an alternative to the winding device 26 described above, it is possible to use a winding device comprising a cableway in the form of a gutter comprising a plurality of interconnected sections so as to permit relative rotational movement of limited amplitude between two successive sections. The optical fibre is then fixed to the cableway and follows its movements. The amplitude of the relative rotational movement between two successive sections is such that the optical fibre is not bent beyond a limit above which the laser beam would suffer losses in the optical fibre and beyond which the optical fibre would be damaged.

In practice, in this embodiment shown in FIG. 5, good results have been obtained in resurfacing tubes having an inside diameter of less than 250 mm, using the following components: confinement tubes 18 and 19 having a diameter of about 70 mm, the tube 18 having a length of about 1200 mm; a diode laser of 3.5 kW power; a lens 22 having a focal length of about 60 mm; a lens 17 having a focal length of about 300 mm; a lens 13 having a focal length of about 177 mm; a lens 15 having a focal length of about 100 mm, producing a laser spot of 4 to 5 mm in size in its focal plane; and a projection nozzle according to document U.S. Pat. No. 5,418,350.

The present invention is not limited to the embodiments that have been explicitly described, rather it includes the various alternative forms and generalisations thereof that are contained within the field of the following claims.

1. Device for resurfacing a concave face of a tubular part by supplying resurfacing material and energy by a laser, comprising:
a diode laser for generating a laser beam,
resurfacing material delivery means for delivering the resurfacing material close to a resurfacing zone on the concave face of the tubular part to be resurfaced,
laser beam delivery means and directing means for directing the laser beam into the resurfacing zone, the laser beam delivery means conducting the laser beam over a penetration length along a penetration direction and then the directing means deflecting the laser beam into a radial direction away from the penetration direction,
wherein:
the resurfacing material is based on hard refractory particles and metal alloy particles,
the laser beam delivery means and the directing means comprise a first convergent lens, the optical axis of which is oriented along the penetration direction, which lens receives the laser beam coming from the diode laser,
the laser beam delivery means and the directing means comprise a mirror which receives the laser beam coming from the first convergent lens and sends said beam along the radial direction away from the penetration direction,
the laser beam delivery means and the directing means comprise a second convergent lens which receives the laser beam coming from the mirror and makes the laser beam converge close to the resurfacing zone, and
an optical insert makes the laser beam coming from the diode laser along the penetration direction converge near the object focal point of the first convergent lens.

2. Device according to claim 1, wherein the optical insert includes an optical fibre that collects the laser beam coming from the diode laser and delivers it close to the object focal point of the first convergent lens.

3. Device according to claim 1, wherein the optical insert comprises a third convergent lens making the laser beam coming from the diode laser converge near the object focal point of the first convergent lens.

4. Device according to claim 3, wherein the optical insert includes an optical fibre that collects the laser beam coming from the diode laser and delivers it close to the object focal point of the third convergent lens.

5. Device according to claim 3, wherein:
the optical insert comprises a fourth convergent lens, which receives the laser beam coming from the diode laser,
the third convergent lens receives the laser beam coming from the fourth convergent lens,
the diode laser is placed close to the object focal point of the fourth convergent lens, and
the image focal point of the third convergent lens coincides substantially with the object focal point of the first convergent lens.

6. Device according to claim 3, wherein:
the optical insert comprises a fourth convergent lens, which receives the laser beam coming from the diode laser,
the third convergent lens receives the laser beam coming from the fourth convergent lens,
the image focal point of the third convergent lens coincides substantially with the object focal point of the first convergent lens, and
an optical fibre collects the laser beam coming from the diode laser and delivers it close to the object focal point of the fourth convergent lens.

7. Device according to claim 6, wherein:
the fourth convergent lens is substantially perpendicular to the penetration direction and substantially parallel to the radial direction,
the second convergent lens and the fourth convergent lens are placed radially on either side of the penetration direction,
the optical insert includes an additional mirror which receives the laser beam coming from the fourth convergent lens and sends the laser beam back along the penetration direction, and
the optical fibre is placed as a winding on a winding device.

8. Device according to claim 1, wherein the optical insert, the first convergent lens and the mirror are contained within a double-walled hollow confinement tube, a coolant circulating between the walls.

9. Device according to claim 8, wherein:
the radial direction along which the mirror sends back the laser beam coming from the first convergent lens is substantially perpendicular to the penetration direction,
the optical axis of the second convergent lens substantially coincides with the radial direction,
the resurfacing material delivery means comprise a nozzle with a generally conical internal wall with its point oriented towards the outlet and the apex of which is pierced, thus forming the outlet orifice, and
the outlet orifice of the nozzle is substantially coaxial with the optical axis of the second convergent lens.

10. Device according to claim 1, wherein it comprises:
a mandrel for rotating the tubular part to be resurfaced, and
first displacement means for providing a relative displacement along the penetration direction between, on the one hand, the tubular part to be resurfaced and, on the other hand, the subassembly comprising the laser beam delivery means and the directing means, in order to make this subassembly penetrate into the tubular part to be resurfaced.

11. Device according to claim 10, wherein it includes second displacement means for providing a relative displacement along a radial direction between, on the one hand, the tubular part to be resurfaced and, on the other hand, the subassembly comprising the laser beam delivery means and the directing means.
